(19) United States
(12) Patent Application Publication
(10) Pub. No.: US 2024/0242147 A1
(43) Pub. Date: Jul. 18, 2024

(54) SYSTEMS AND METHODS FOR OPTIMAL SUPPLY PLANNING

(71) Applicant: VIA TRANSPORTATION, INC., New York, NY (US)

(72) Inventors: Clinton BOYS, London (GB); Shahar CHEN, Tel Aviv (IL); Yagil ENGEL, Tel Aviv (IL); Shiran EZRA, Ramat Gan (IL); Shmulik MARCOVITCH, Tel Aviv (IL); Tom SHLOMO, Tel Aviv (IL); Amir YAVNEH, Haifa (IL)

(73) Assignee: VIA TRANSPORTATION, INC., New York, NY (US)

(21) Appl. No.: 18/410,279

(22) Filed: Jan. 11, 2024

Related U.S. Application Data
(60) Provisional application No. 63/479,795, filed on Jan. 13, 2023.

(51) Int. Cl. G06Q 10/0631; G06Q 50/43

(52) U.S. Cl. CPC G06Q 10/06315; G06Q 10/063118; G06Q 50/43

(57) ABSTRACT

A system and method are provided for optimized supply planning for a rideshare management system. A desired budget, a desired rate of met demand and/or one or more shift constraints can be received as inputs to the optimizing supply planning. The optimized supply planning can vary based on which objective is to be optimized (e.g., budget or met demand). The optimized supply planning can also be based on historical data, the one or more shift constraints, and additional objectives.

### CROSS REFERENCE TO RELATED APPLICATIONS

This application claims the benefit of and priority to U.S. Provisional Patent Application No. 63/479,795, filed Jan. 13, 2023, the entire contents of which are owned by the assignee of the instant application and incorporated herein by reference in their entirety.

### FIELD OF THE INVENTION

The invention relates generally to vehicle ridesharing and systems and methods for ridesharing management.

### BACKGROUND OF THE INVENTION

Recent years have witnessed increasing interest and development in the field of vehicle sharing, where one or more riders may share the same vehicle for a portion of their rides. Ridesharing may save ride costs, increase vehicle utilization, and reduce air pollution. A rider may use a ridesharing service through a ridesharing service application accessed by the rider's mobile device.

Ridesharing service can be performed with a car, van, and/or bus. Ridesharing service can include scheduling pickup-drop offs of riders, determining routes for vehicles, modifying routes for vehicles on the fly. Ridesharing services can operate as fixed route, semi-fixed route, and/or full point-to-point services, and vehicles can be commanded to operate in any of those modes and/or be switched between those service types.

A ridesharing management system can include a system to manage a fleet of vehicles. The system to manage the fleet of vehicles can include a user interface. The ridesharing management system can include algorithms to schedule the fleet to optimize performance of the fleet. The ridesharing management system can provide a user interface for an operator to interact with the ridesharing management system through. A rider and/or driver can have an application (e.g., an app on a smartphone or tablet) to communicate with the ridesharing management system. The rider can schedule ride services via the app, and the driver can communicate information (e.g., current location, pickup time, availability, drop off time) to the ridesharing management system via its app. In some scenarios, the rider can schedule daily and/or weekly rides on a schedule for a set duration of time. In some scenarios, the driver app can instruct the driver to pickup, drop off locations, and/or specific routes to take.

The ridesharing management system (e.g., service operators) can cause supply (e.g., the number of vehicle hours available to be used) to remain tightly coupled to demand (e.g., the number of vehicle hours to be used) in order to, for example, optimize service efficiency. At the same time, service operators may take driver satisfaction and/or engagement into account, which can include adhering to various labor rules and/or union requirements, and which may also include enforcing some structure and/or continuity in shift plans, even sometimes at the cost of some efficiency.

### SUMMARY

Advantages of the invention can include an ability to optimize shift scheduling around existing (e.g., manual) shifts data. Advantages of the invention can include taking into account user preferences for minimizing changes. Advantages of the invention can also include allowing some changes in manual shifts (e.g., even violating) when they are most beneficial. Advantages of the invention can also a multiple solution mode: sample a subset of values for multiple preference parameters (e.g., efficiency, minimizing changes, minimizing undersupply, etc) to provide a set of solutions which can cover a spectrum of tradeoffs, and letting the user select the most preferred point on the spectrum.

Advantages of the invention can also include using historical data to calculate supply contribution of vehicles at the margins of their shifts, thus improving the accuracy of the planning. Advantages of the invention can also include allowing solving the optimization problem efficiently (e.g., a typical problem takes just 1-2 minutes on average).

In one aspect, the invention involves a system for providing optimized supply planning for a rideshare management system. The system can include a communications interface configured to receive a desired budget for the optimized supply planning over a future period of time and receive one or more shift constraints for the optimized supply planning. The system can include at least one processor configured to determine expected demand for the future period of time based on historical demand data, determine quality of service as a function of a number of vehicles for each of a plurality of time bins based on the expected demand, and determine optimized shifts for the rideshare management system that maximizes the quality of service based on the function in each of the plurality of time bins, the one or more shift constraints, the desired budget or any combination thereof.

In some embodiments, the processor is further configured to assign drivers to each of the optimized shifts based on driver availability, driver preferences, labor rules, salaries, or any combination thereof.

In some embodiments, the budget is total cost for operation over the future period of time, number of hours for vehicles over the future period of time, or any combination thereof.

In some embodiments, determining optimized shifts is further based one or more set of predetermined shifts for the optimal supply planning, one or more supply plan objectives or any combination thereof.

In some embodiments, determining the quality of service is further based on machine learning. In some embodiments, determining the quality of service is further based on expected weather, expected time of day, or any combination thereof.

In some embodiments, determining the quality of service is further based on met demand, on-time performance, time it takes to serve an on-demand ride, or any combination thereof. In some embodiments, determining the optimized shifts further involves determining contribution that a shift at a start of the shift, end of a shift or around a break time during the shift or any combination thereof has on the number of available vehicles. In some embodiments, the contribution is a fractional contribution to the number of available vehicles.

In another aspect, the invention includes a method for providing optimized supply planning for a rideshare management system. The method involves receiving, via a communication interface, a desired budget for the optimized supply planning over a future period of time and receiving, via the communication interface, one or more shift constraints for the optimized supply planning. The method can also involve determining, via a processor, an expected demand for the future period of time based on historical demand data, determining, via the processor, quality of service as a function of a number of vehicles for each of a plurality of time bins based on the expected demand, and determining, via the processor, optimized shifts for the rideshare management system that maximizes the quality of service based on the function in each of the plurality of time bins, the one or more shift constraints, the desired budget or any combination thereof.

In some embodiments, the method involves assigning drivers to each of the optimized shifts based on driver availability, driver preferences, labor rules, salaries, or any combination thereof.

In some embodiments, the budget is total cost for operation over the future period of time, number of hours for vehicles over the future period of time, or any combination thereof.

In some embodiments, determining optimized shifts is further based one or more set of predetermined shifts for the optimal supply planning, one or more supply plan objectives or any combination thereof.

In some embodiments, determining the quality of service is further based on machine learning. In some embodiments, determining the quality of service is further based on expected weather, expected time of day, or any combination thereof.

In some embodiments, determining the quality of service is further based on met demand, on-time performance, time it takes to serve an on-demand ride, or any combination thereof. In some embodiments, determining the optimized shifts further involves determining, via the processor, contribution that a shift at a start of the shift, end of a shift or around a break time during the shift or any combination thereof has on the number of available vehicles. In some embodiments, the contribution is a fractional contribution to the number of available vehicles.

In another aspect, the invention includes a system for providing optimized supply planning for a rideshare management system. The system can include a communications interface configured to receive a desired rate of met demand, and receive one or more shift constraints, or any combination thereof. The system can include at least one processor configured to determine expected demand for a future period of time based on historical demand data, determine required supply for the future period of time based on the expected demand and the desired rate of met demand, and determine optimized shifts for a plurality of vehicles in the rideshare management systems based on the determined required supply, one or more supply plan objectives, one or more shift constraints, or any combination thereof.

In some embodiments, determining optimized shifts is further based one or more set of predetermined shifts for the optimal supply planning, one or more supply plan objectives.

In some embodiments, the processor is further configured to assign drivers to each of the optimized shifts based on the determined optimized shifts.

In some embodiments, determining required supply for the future period of time comprises determine demand level for each of a plurality of time bins to create an expected demand for each time bin based on historical met demand, determine a percentage of demand met as a function of vehicle supply for each of the plurality of time bins based on the historical met demand, and create a target supply vector based on the function.

In some embodiments, determining the demand level is based on machine learning. In some embodiments, the demand level for each of the plurality of time bins is further based on expected weather.

In some embodiments, determining required supply for the future period of time is further based on number of bookings for a future period, expected number of passengers vs. expected number of bookings, weather prediction, or any combination thereof.

In some embodiments, determining optimized shifts is further based on the target supply vector. In some embodiments, determining the optimized shifts further includes determining contribution that a shift at a start of the shift, end of a shift or around a break time during the shift or any combination thereof has on a number of available vehicles.

In some embodiments, the contribution is a fractional contribution to the number of available vehicles.

In another aspect, the invention includes a method for providing optimized supply planning for a rideshare management system. The method can involve receiving, via a communications interface, a desired rate of met demand, and receiving, via a communications interface, one or more shift constraints, or any combination thereof. The method can involve determining, via a processor, expected demand for a future period of time based on historical demand data, determining, via a processor, required supply for the future period of time based on the expected demand and the desired rate of met demand, and determining, via a processor, optimized shifts for a plurality of vehicles in the rideshare management systems based on the determined required supply, one or more supply plan objectives, one or more shift constraints, or any combination thereof.

In some embodiments, determining optimized shifts is further based one or more set of predetermined shifts for the optimal supply planning, one or more supply plan objectives.

In some embodiments, the processor is further configured to assign drivers to each of the optimized shifts based on the determined optimized shifts.

In some embodiments, determining required supply for the future period of time comprises determine demand level for each of a plurality of time bins to create an expected demand for each time bin based on historical met demand, determine a percentage of demand met as a function of vehicle supply for each of the plurality of time bins based on the historical met demand, and create a target supply vector based on the function.

In some embodiments, determining the demand level is based on machine learning. In some embodiments, the demand level for each of the plurality of time bins is further based on expected weather.

In some embodiments, determining required supply for the future period of time is further based on number of bookings for a future period, expected number of passengers vs. expected number of bookings, weather prediction, or any combination thereof.

In some embodiments, determining optimized shifts is further based on the target supply vector. In some embodiments, determining the optimized shifts further includes determining contribution that a shift at a start of the shift, end of a shift or around a break time during the shift or any combination thereof has on a number of available vehicles.

In some embodiments, the contribution is a fractional contribution to the number of available vehicles.

The foregoing general description and the following detailed description are exemplary and explanatory only and are not restrictive of the claims.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a ridesharing management system, according to some embodiments of the invention.

FIG. 2 is a diagram of a mobile communications device associated with a ridesharing management system, according to some embodiments of the invention.

FIG. 3 is a diagram of an automated ridesharing dispatch system, including ridesharing management server associated with a ridesharing management system, according to some embodiments of the invention.

FIG. 4A is a flow diagram for a method for providing optimal supply planning for a ridesharing management system, according to some embodiments of the invention.

FIG. 4B is a flow diagram for a method for providing optimal supply planning for a ridesharing management system, according to some embodiments of the invention.

FIG. 5 shows an example of demand level versus demand at the future time period, according to some embodiments of the invention.

FIG. 6A shows an example of planned shifts at the future time period and a list of available vehicles, according to some embodiments of the invention.

FIG. 6B shows an example of determined supply versus actual supply at the future time period, according to some embodiments of the invention.

FIG. 7 shows multiple supply options for various met demand levels according to some embodiments of the invention.

FIG. 8 shows an example of providing multiple shift options to a user, according to some embodiments of the invention.

FIG. 9 shows an expanded information view of a selection option of FIG. 8, according to some embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

FIG. 1 is a diagram of a ridesharing management system 100, according to some embodiments of the invention. The ridesharing management system 100 includes one or more user devices 120A-120F (collectively referred to as user devices 120) associated with respective users 130A-130F, a network 140, a ridesharing management server 150, and a database 170. The user devices 120 can be mobile communications devices.

The users 130A-130F can be riders, drivers and/or other computing systems. In FIG. 1, users 130A-130C are riders, users 130D-130E are drivers, and user 130F is an autonomously driven vehicle user. The user devices 120A-120F can be associated with riders, drivers, and/or other computing systems, such that user devices 120A-120C can be referred to as rider devices, 120D-120E can be referred to as driver devices, and user device 120F can be referred to as a driving-control device.

The network 140 can be coupled to the user devices 120 to facilitate communications between the user devices 120 and the ridesharing management server 150. For example, the rider 130A can request a ride via the rider device 120A that is a smart phone. The request can be transmitted by the user device 120A to the ridesharing management server 150 through the network 140. The ridesharing management server 150 can transmit a route to the driver device 120E to instruct the driver 130E to pick-up the rider 130A. The ridesharing management server 150 can transmit a message to the rider 130A via the rider device 120A indicating that the driver 130E is on its way and the message can instruct the rider 130A to a particular pick-up location.

The network 140 can facilitate communications that include receiving ride requests and/or other ride related input from or sending confirmations to the rider devices 120A-120C and/or sending ride service assignments to the driver devices 120D-120E and driving-control device 120F.

The network 140 can be any type of network that provides communications, exchanges information, and/or facilitates the exchange of information between ridesharing management server 150 and user devices 120. For example, network 140 can be the Internet, a Local Area Network, a cellular network, a public switched telephone network (“PSTN”), and/or other suitable connection(s) that enables ridesharing management system 100 to send and/or receive information between the components of the ridesharing management system 100. The network 140 can be wired and/or wireless depending on the type of connection to the network 140. Although the network 140 is shown herein as a cloud, the network 140 can include a variety of computing components, including wired and wireless components that in various networked configurations to facilitate desired communication between components.

The network 140 can support a variety of messaging formats as is known in the art, and may support a variety of services and applications for user devices 120. For example, the network 140 can support navigation services for user devices 120, such as directing users and/or ridesharing service vehicles to pick-up and/or drop-off locations.

The ridesharing management server 150 can be a system that communicates with and/or is part of a communication service provider which provides a variety of data or services, such as voice, messaging, real-time audio/video, to users, such as users 130A-130E. The ridesharing management server 150 can be a computer-based system including computer system components, desktop computers, workstations, tablets, handheld mobile communications devices, memory devices, and/or internal network(s) connecting the components.

The ridesharing management server 150 can receive information from user devices 120 over the network 140, process the information, store the information, and/or transmit information to mobile communications devices 120 over network 140. The ridesharing management server 150 can receive ride requests from user devices 120A-120C. The ridesharing management server 150 can send ride confirmation and/or ride fare information to user devices 120A-120C. The ridesharing management server 150 can send ride service assignments (e.g., including pick-up and/or drop-off location information) to driver devices 120D and 120E, and driving-control device 120F.

The ridesharing management server 150 can receive user input from user devices 120A-120C. For example, the ridesharing management server 150 can receive various ride service parameters, such as walking distance to a pick-up location, maximum delay of arrival/detour, and/or maximum number of subsequent pick-ups.

The rideshare vehicle can be a car, van, SUV, truck, bus or any kind of vehicle suitable for human transportation. In some embodiments, a vehicle is a taxi. In some embodiments, a rideshare vehicle can be an autonomous vehicle, wherein a control device integrated with the vehicle or a management system separate from the vehicle can send operational messages.

The ridesharing management server 150 can calculate ride fares based on a solo portion of a user's ride and a shared portion of the ride. The ride fare calculation can be based on various ride service parameters set by the user, such as the walking distance involved in the ride, and/or user selection regarding toll road usage.

The database 170 may include one or more physical and/or virtual storages coupled with the ridesharing management server 150. The database 170 can store user account information (e.g., registered rider and/or driver accounts) and/or corresponding user profiles (e.g., contact information, profile photos, and/or associated mobile communications device information). User account information for a rider can include ride history, service feedback, complaints, and/or comments. User account information for a driver can include number of ride service assignments completed, ratings, and/or ride service history information. The database 170 can store various ride requests received from user devices 120A-120C. Each ride request can include a corresponding starting point and desired destination information, user input regarding various service parameters, pick-up and drop-off locations, time of pick-up and drop-off, ride fares, and/or other user feedback (e.g., user comments).

The database 170 may include traffic data, maps, and/or toll road information, which may be used for ridesharing service management. The traffic data may include historical traffic data and/or real-time traffic data regarding a certain geographical region. The traffic data may be used to determine traffic conditions. Traffic data and traffic conditions can be used to estimate pick-up and drop-off times for riders and/or determine an optimal route for a particular ride or for all rides. The real-time traffic data may be received from a real-time traffic monitoring system, which may be integrated into or independent from ridesharing management system 100.

The maps may include map information (e.g., roads, streets and/or distances) typically used for navigation purposes. The map information can be used to determine potential routes and in transit routes for the rideshare vehicles and/or guiding the users to a pick-off or drop-off location. Guiding the users to a pick-up or drop off location can include displaying a map, outputting audio, displaying a list of directions or any combination thereof. The in transit routes can be modified based on adding or reducing passengers, the driver driving off the route, speed and/or other updates. Toll road information may include amount of toll charges regarding certain roads, and any change or updates thereof. Toll road information may be used to calculate ride fares. In some embodiments, a rider can specify that the rideshare vehicle route avoids toll roads.

The data stored in database 170 can be transmitted to the ridesharing management server 150 for accommodating ride requests. In some embodiments, the database 170 is stored in a cloud-based server (not shown) that is accessible by the ridesharing management server 150 and/or user devices 120 through the network 140. In some embodiments, the database 170 reside within the ridesharing management server 150.

The database 170 can include a list of ridesharing vehicles with their corresponding shift availability. The shift availability can include day, start time, stop time, maximum shift duration, and/or labor rules associated with the respective driver for the shift. The shift availability can be input by a user (e.g., a ridesharing provider).

During operation, the ridesharing management server 150 can communicate with the driving-control device 120F to direct the autonomous vehicle 130F to pick up and drop off riders 130A-130C. In some embodiments, autonomous vehicles capable of detecting objects on the road and navigate to designated locations may be utilized for providing ridesharing services.

In various embodiments, the ridesharing management server 150 is implemented on a single server or on multiple servers. Each server can be on a single computing device or distributed among multiple computing devices. In various embodiments, the ridesharing management system 100 includes multiple ridesharing management servers, and each ridesharing management server can serve a category of ridesharing services, ridesharing services associated with a certain category of service vehicles, and/or ridesharing services in a specific geographical region. For example, a first ridesharing management server can direct a first fleet of vehicles, a second ridesharing management server can direct a second fleet of vehicles and a third ridesharing server can direct a third fleet of vehicles. The first, second and third fleet of vehicles can be on-demand services, fixed-route services, or any combination thereof.

In some embodiments, a plurality of ridesharing management servers collectively provides a dynamic and integrated ridesharing service system.

As shown in FIG. 1, users 130A-130E may include a plurality of users 130A-130C, and a plurality of drivers 130D and 130E, who may communicate with one another, and with ridesharing management server 150 using various types of user devices 120 that are mobile communications devices. For example, the mobile communications device can include a display such as a television, tablet, computer monitor, video conferencing console, or laptop computer screen. A mobile communications device 120 can further include video/audio input devices such as a microphone, video camera, keyboard and/or web camera. A mobile communications device 120 can include mobile devices such as a tablet or a smartphone having display and/or video/audio capture capabilities. The mobile communications device can include one or more software applications that can facilitate the mobile communications devices to engage in communications, such as IM, VoIP, video conferences. For example, user devices 130A-130C can send requests to ridesharing management server 150, and receive confirmations therefrom. Drivers 130D and 130E can use their respective user devices to receive ride service assignments and navigation information from ridesharing management server 150, and may contact the users with their respective user devices.

In some embodiments, a user may directly hail a vehicle by hand gesture or verbal communication, such as traditional street vehicle hailing. In such embodiments, once a driver accepts the request, the driver can use his respective user device to input the ride request information. Ridesharing management server 150 can receive the information, and accordingly assign one or more additional ride service assignments to the same vehicle, for example, subsequent ride requests received from other user devices 120 through network 140.

In some embodiments, driver devices 120D and 120E, and driving-control device 120F may be embodied in a vehicle control panel, as a part of the vehicle control system associated with a particular vehicle. For example, a traditional taxi company may install a drive device in all taxi vehicles managed by the taxi company. In some embodiments, driver devices 120D and 120E, and driving-control device 120F, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device, without using a user device providing ridesharing service.

In some embodiments, the rideshare management server 150 can receive a list of ride requests from a user (e.g., a rideshare provider, not shown). The rideshare management system can receive the list of ride requests for a predefined time period, e.g., at night for the following day, for a scheduled 24 period, or any defined time period. Each ride in the list of ride requests can include a pick-up location, drop-off location, desired pick-up time, desired drop off time, maximum delay between desired pick-up time and actual pick-up time, maximum delay between desired drop off time and actual drop-off time, maximum distance between pick-up location and actual pick-up location, maximum distance between drop-off location and actual drop-off location, or any combination thereof.

FIG. 2 is a diagram of a mobile communications device 200 (e.g., user device 120 100 as shown above in FIG. 1) associated with a ridesharing management system (e.g. ridesharing management system 100 as shown above in FIG. 1), according to some embodiments of the invention. The mobile communications device 200 can be used to implement computer programs, applications, methods, processes, or other software to perform embodiments of the invention described in herein. For example, turning back to FIG. 1, rider devices 120A-120C, driver devices 120D and 120E, and driving-control device 120F may respectively be installed with a rider side ridesharing application, and a corresponding driver side ridesharing application.

Turning back to FIG. 2, the mobile communications device 200 can include a memory interface 202, one or more processors 204 such as data processors, image processors and/or central processing units, and/or a peripherals interface 206. The Memory interface 202, one or more processors 204, and/or peripherals interface 206 can be separate components or can be integrated in one or more integrated circuits. The various components in mobile communications device 200 may be coupled by one or more communication buses or signal lines.

Sensors, devices, and subsystems can be coupled to peripherals interface 206 to facilitate multiple functionalities. For example, a motion sensor 210, a light sensor 212, and a proximity sensor 214 may be coupled to peripherals interface 206 to facilitate orientation, lighting, and/or proximity functions. One or more sensors 216 can be connected to peripherals interface 206, such as a positioning system (e.g., GPS receiver), a temperature sensor, a biometric sensor, and/or other sensing devices. A GPS receiver can be integrated with, or connected to, mobile communications device 200. For example, a GPS receiver may be included in mobile telephones, such as smartphone devices. GPS software can allow mobile telephones to use an internal and/or external GPS receiver (e.g., connecting via a serial port or Bluetooth). A camera subsystem 220 and/or an optical sensor 222, e.g., a charged coupled device (“CCD”) or a complementary metal-oxide semiconductor (“CMOS”) optical sensor, can be used to facilitate camera functions, such as recording photographs and video clips.

Communication functions can be facilitated through one or more wireless/wired communication subsystems 224, which can include an Ethernet port, radio frequency receivers and transmitters and/or optical (e.g., infrared) receivers and/or transmitters. The specific design and implementation of wireless/wired communication subsystem 224 may depend on the communication network(s) over which mobile communications device 200 is intended to operate. For example, in some embodiments, mobile communications device 200 may include wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and/or telephony functions.

I/O subsystem 240 may include touch screen controller 242 and/or other input controller(s) 244. Touch screen controller 242 may be coupled to touch screen 246. Touch screen 246 and touch screen controller 242 may for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 may be coupled to other input/control devices 248, such as one or more buttons, rocker switches, thumb-wheel, infrared port, USB port, and/or a pointer device such as a stylus. Touch screen 246 may for example, also be used to implement virtual or soft buttons and/or a keyboard.

Memory interface 202 may be coupled to memory 250. Memory 250 includes high-speed random access memory and/or non-volatile memory, such as one or more magnetic disk storage devices, one or more optical storage devices, and/or flash memory (e.g., NAND, NOR). Memory 250 may store an operating system 252, such as DRAWIN, RTXC, LINUX, iOS, UNIX, OS X, WINDOWS, or an embedded operating system such as VXWorkS. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions.

In some embodiments, communication instructions 254 may include software applications to facilitate connection with ridesharing management server (e.g., ridesharing management server 150 as described above in FIG. 1) that handles vehicle ridesharing requests. Graphical user interface instructions 256 may include a software program that facilitates a user associated with the mobile communications device to receive messages from ridesharing management server 150, provide user input, and so on. For example, a user may send ride requests and ride service parameters to a ridesharing management server and receive ridesharing proposals and confirmation messages. A driver may receive ride service assignments from ridesharing management server, and provide ride service status updates.

Each of the above identified instructions and applications may correspond to a set of instructions for performing one or more functions described above. These instructions need not be implemented as separate software programs, procedures, or modules. Memory 250 may include additional instructions or fewer instructions. Furthermore, various functions of mobile communications device 200 may be implemented in hardware and/or in software, including in one or more signal processing and/or application specific integrated circuits.

FIG. 3 is a diagram of an automated ridesharing dispatch system 300, including a ridesharing management server (e.g., ridesharing management server 150 as described above in FIG. 1) associated with a ridesharing management system (e.g., ridesharing management system 100 as described above in FIG. 1), according to some embodiments of the invention. The ridesharing management server 150 can include a bus 302 (or other communication mechanism), which interconnects subsystems and/or components for transferring information within the ridesharing management server 150.

As shown in FIG. 3, automated ridesharing dispatch system 300 may include one or more processors 310, one or more memories 320 storing programs 330 including, for example, server app(s) 332, operating system 334, and data 340, and a communications interface 360 (e.g., a modem, Ethernet card, or any other interface configured to exchange data with a network, such as network 140 in FIG. 1). Automated ridesharing dispatch system 300 can communicate with an external database (e.g., external databased 170 as described above with respect to FIG. 1). Automated ridesharing dispatch system 300 can include a single server (e.g., ridesharing management server 150) and/or can be configured as a distributed computer system including multiple servers, server farms, clouds, and/or computers that can interoperate to perform one or more of the processes and functionalities associated with embodiments.

The ridesharing management server 150 can be a computer platform that provides services via a network, such as the Internet, it can use virtual machines that may not correspond to individual hardware. The computational and/or storage capabilities can be implemented by allocating appropriate portions of desirable computation/storage power from a scalable repository, such as a data center and/or a distributed computing environment.

Processor 310 may be one or more processing devices configured to perform functions of the disclosed methods, such as a microprocessor manufactured by Intel™ or manufactured by AMD™. Processor 310 can include a single core or multiple core processors executing parallel processes simultaneously. For example, processor 310 may be a single core processor with virtual processing technologies. In some embodiments, processor 310 can uses logical processors to simultaneously execute and/or control multiple processes. Processor 310 can implement virtual machine technologies, and/or other technologies to provide the ability to execute, control, run, manipulate, and/or store multiple software processes, applications, programs. In some embodiments, processor 310 includes a multiple-core processor arrangement (e.g., dual and/or quad core) to provide parallel processing functionalities to allow ridesharing management server 150 to execute multiple processes simultaneously. It is appreciated by one of ordinary skill in the art that other types of processor arrangements can be implemented that provide for the capabilities disclosed herein.

Memory 320 can be a volatile or non-volatile, magnetic, semiconductor, tape, optical, removable, non-removable, or other type of storage device or tangible or non-transitory computer-readable medium that stores one or more program(s) 330 such as server apps 332 and operating system 334, and data 340. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The ridesharing management server (e.g., ridesharing management server 150 as described above in FIG. 1) can include one or more storage devices configured to store information used by processor 310 (or other components) to perform certain functions related to the embodiments. For example, the ridesharing management server may include memory 320 that includes instructions to enable processor 310 to execute one or more applications, such as server apps 332, operating system 334, and/or any other type of application or software known to be available on computer systems. In some embodiments, the instructions, and/or application programs, can be stored in an external database 170 (which can also be internal to ridesharing management server 150) or external storage communicatively coupled with ridesharing management server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 320 and database 170 may include one or more memory devices that store data and instructions used to perform one or more features of the disclosed embodiments. Memory 320 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, ridesharing management server 150 may be communicatively connected to one or more remote memory devices (e.g., remote databases (not shown)) through network 140 or a different network. The remote memory devices can be configured to store information that ridesharing management server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 330 may include one or more software modules causing processor 310 to perform one or more functions of the disclosed embodiments. Moreover, processor 310 may execute one or more programs located remotely from one or more components of the ridesharing management system 100. For example, ridesharing management server 150 may access one or more remote programs that, when executed, perform functions related to disclosed embodiments.

In the presently described embodiment, server app(s) 332 may cause processor 310 to perform one or more functions of the disclosed methods. For example, devices associated with users, drivers and autonomous vehicles may respectively be installed with user applications for vehicle ridesharing services, and driver applications for vehicle ridesharing services. Further, a mobile communications device may be installed with both the driver applications and the user applications, for uses in corresponding situations.

In some embodiments, other components of ridesharing management system 100 may be configured to perform one or more functions of the disclosed methods. For example, mobile communications devices 120 may be configured to calculate estimate pick-up and drop-off times based on a certain ride request, and may be configured to calculate estimate ride fares. As another example, mobile communications devices 120 may further be configured to provide navigation service, and location service, such as directing the user to a particular pick-up or drop-off location, and providing information about a current location of the respective user or vehicle to ridesharing management server 150.

In some embodiments, program(s) 330 may include operating system 334 performing operating system functions when executed by one or more processors such as processor 310. By way of example, operating system 334 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, the disclosed embodiments may operate and function with computer systems running any type of operating system 334. Ridesharing management server 150 may also include software that, when executed by a processor, provides communications with network 140 through communications interface 360 and/or a direct connection to one or more mobile communications devices 120. Specifically, communications interface 360 may be configured to receive ride requests (e.g., from user devices 120A-120C) headed to differing destinations, and receive indications of the current locations of the ridesharing vehicles (e.g., from driver devices 120D and 120E or driving-control device 120F). In one example, communications interface 360 may be configured to continuously or periodically receive current vehicle location data for the plurality of ridesharing vehicles that are part of ridesharing management system 100. The plurality of ridesharing vehicles can be a car fleet, bus fleet or any combination thereof. The current vehicle location data may include global positioning system (GPS) data generated by at least one GPS component of a mobile communications device 120 associated with each ridesharing vehicle.

In some embodiments, data 340 may include, for example, profiles of users, such as user profiles or driver profiles. User profiles can include contact information, profile photos, user account information and/or associated mobile communications device information. Rider account information can include ride history, service feedbacks, complaints, and/or comments. Driver account information can include number of ride service assignments completed, ratings, ride service history, rider ride history, driver service record, and/or communications between a driver and a rider regarding a particular ride request. In some embodiments, data 340 may further include traffic data, toll road information, and navigation information, which may be used for handling and accommodating ride requests.

Automated ridesharing dispatch system 300 may also include one or more I/O devices 350 having one or more interfaces for receiving signals or input from devices and providing signals or output to one or more devices that allow data to be received and/or transmitted by automated ridesharing dispatch system 300. For example, automated ridesharing dispatch system 300 may include interface components for interfacing with one or more input devices, such as one or more keyboards, mouse devices, and the like, that enable automated ridesharing dispatch system 300 to receive input from an operator or administrator (not shown).

FIG. 4A is a flowchart for a method for providing optimal supply planning (e.g., via a rideshare management server 150 over a network 140, as described above in FIG. 1) for a rideshare management system having a fleet of ridesharing vehicles (e.g., users in fleet 130D, 130E, and 130F, as described above in FIG. 1), according to some embodiments of the invention.

The method can involve receiving (e.g., via a rideshare management server 150 over a network 140, as described above in FIG. 1) a desired rate of met demand (Step 410). The desired rate of demand can be a percentage of demand that is to be met. For example, if the demand is for 100 rides and the desired rate of demand is 80%, then the minimum number of rides that are expected to be served can be 80. The desired rate of met demand can be input by a user of the rideshare management system, based on a geographical location of vehicles in the fleet, or any combination thereof. In various embodiments, the desired rate of met demand is 80%, 85%, 90%, 95% or any value.

The method can involve receiving one or more set of predetermined shifts for the optimal supply planning, one or more supply plan objectives, one or more shift constraints, or any combination thereof (Step 420). The one or more set of predetermined shifts can be received from a user. The one or more set of predetermined shifts can be based on availability of the drivers. For example, the one or more set of predetermined shifts can be for example, shift 1: 8 am-4 pm, break at 11:30-12, start and end at “north zone lot”.

The method can involve determining expected demand for a future period of time based on historical demand data (Step 430).

In some embodiments, time series models are used to determine expected demand for a planning period (e.g., a future period, for example, one day, multiple days, a week, or any duration period) based on historical data. In some embodiments, the desired rate of met demand can be determined by using a weighting running average of historical demand data. In some embodiments, seasonality and trend can be accounting for in the desired rate of met demand.

The method can involve determining required supply for the future period of time based on the expected demand and the desired rate of met demand (Step 440). The required supply for the future period of time based on number of bookings for a future period, expected number of passengers vs. expected number of bookings, weather prediction, or any combination thereof.

A plurality of time bins can be determine for a time period. The plurality of time bins can be a set of time for the planning period. The time bins can be a ½ hour, 15 minutes or any duration as input by a user.

For each time bin, a demand level can be determined. The demand level can be based on historical demand. The historical demand can be used to train machine learning algorithms such that the machine learning algorithms can learn an expected demand based on the historical demand and a similarity between the historical demand and the expected demand.

The historical demand used can be any desired historical demand. For example, the historical demand can be the historical demand for the same geographical regional the required supply for the future period is to be determined for. The historical demand can be historical demand for urban environments, rural environments, service zones, time of day, day of week, weather, for a particular country having for example, the same rules. Each grouping of historical demand can train a different machine learning algorithm. The machine learning algorithms can be deep learning neural networks (e.g., CNN or time series methods such as ARIMA]

A percentage of met demand (or on-time performance “OTP” or expected time of arrival “ETA”) can be determined as a function of vehicle supply for each time bin based on the historical demand. The percentage of met demand can be determined using isotonic regression (e.g., regression which can allow for piecewise-linear functions and that is monotonically increasing). The percentage of met demand can be based on a similarity between the historical demand and the expected demand. The OTP can be average OTP. The ETA can be average ETA.

In some embodiments, before determining demand level, the historical demand data can be filtered. For example, the historical demand data can be filtered based on expected weather, time of day, or any combination thereof.

A target supply vector can be determined based on the percentage of met demand and/or other QoS objectives as a function of vehicle supply, for each time bin. The target supply vector can be a scalar vector showing for various percentages of met demand and/or other QoS objectives (e.g., OTP and/or ETA), the required supply. For example, time bins can be as follows:

8 am- 8:30: 50 vehicles

8:30- 9:00: 55 vehicles

9:00- 9:30: 60 vehicles

9:30- 10:00: 57 vehicles

The optimized shifts can be determined based on obtaining the lowest cost shift plan to achieve the target supply vector.

The method can involve determine optimized shifts for a plurality of vehicles in the rideshare management systems based on the determined required supply, one or more shift objectives, one or more shift constraints and one or more variables, or any combination thereof (Step 450).

Determining optimized shifts can involve generating all (or substantially all) possible shift structures (e.g., lengths, breaks time, breaks lengths) according to labor rules. In some embodiments, the labor rules are input by a user, or retrieved directly from the internet.

A ramp model from a plurality of ramp models can be selected (e.g., loaded from memory). The ramp model can indicate a contribution to supply of a vehicle that is close to the start or end of shifts or around the breaks. For example, if a vehicle is just starting a shift it may take time to leave the depot before it can be counted in the list of available vehicles and time to ramp up to being fully available. The ramp model can determine for each of the time bins for each shift in which contribution to supply is partial. A vehicle which is not during ramp time can contribute a full supply unit. A vehicle during ramp time can contribute some fraction of a supply unit which the ramp model determines.

The ramp model can involve determining a ramp value for each time bin. For example, consider all of the shifts that started at a particular time (e.g., 8 am) and determine how many passengers were served by those shifts in in first time durations (e.g., 15 minutes) in the time bins near the ends of the shifts and around the breaks (e.g., ½ hour to 1 hour) and compare to shifts that were in the middle of the shift at the particular time. Assume that in the start phase there were 2 people on average and in the middle phase there were 5 people on average, then the ramp model is 40% for 8 am. This can be done for every time bin and/or also for parts of the shifts which are not exactly on the edge or close to the break. For example, there can be a ramp value of 40%, for the first time bin of shifts, which start for example, at 3 pm; and then the ramp for the next time bin (which can be farther from the start of the shift) can be 70%.

Determining optimized shifts can also involve creating a linear discrete optimization program (e.g., Mixed Integer Program (“MIP”)). The MIP can be a representation of variables, objectives, and/or constraints.

Variables can include desired rate of met demand, driving hours budget, or any combination thereof.

Objectives can include minimizing shift costs, total penalties and/or total shift costs plus total penalties. Penalties can include: (i) total cost of the selected shifts, and/or (ii) difference, per time bin, between the target supply and the achieved supply, which can takes into account the contribution to supply as described by the ramps model, as described above.

Constraints can include shift constraints, labor rules, breakdown to service zones, vehicle types, available vehicles, vehicle availability schedule, number of riders per vehicle, minimum supply at particular time bins, and the time required for a vehicle to be handed over from the end of one shift to the start of the next shift, existing shifts that must be kept as is or with small allowed changes, or any combination thereof.

The variables can represent a number of shifts of each shift structure which can start at each given time bin. For example, how many shifts of a first structure type starts at time bin 1, how many shifts of a second structure type starts at time bin 1, how many shifts of the first structure type starts at time bin 2. A shift structure can be: Drive 2 hours, break 45 minutes, drive 3.5 hours.

The MIP can find the optimal value given the variables and constraints. The MIP can determine a solution, convert solution to an optimized shift plan with a valid vehicle assignment to each shift. Converting the solution to an optimized shift plan can involve converting to a shift plan by creating shifts according to the variable values selected by (e.g., output by or determined by) the MIP.

The method can involve assigning drivers to each of the optimized shifts based on the determined optimized shifts (Step 460).

The driver assignment can include obtaining an optimized set of shift bundles, each bundle being a plan for each specific driver, according to one or more of the following inputs:
1. A set of shifts for the planning period (e.g., as determined by the shift optimizer or input by the user);
2. Driver availabilities (e.g., days of the week and/or hours per day) per each driver;
3. Driver cost per driver group. The driver cost per driver group can be determined based on drivers regular hours (e.g., per week or per day, and/or the amounts can differ by driver group), overtime, and/or weekend premium;
4. Driver specific absence and/or vacation days. Each of these can be treated differently in the sense of weekly targets and/or fairness;
5. Driver preferences (e.g., days and/or hours per day);
6. A set of weights which can indicate the importance of optimization factors: dollar cost, driver preferences, fairness, and/or consistency of driver shifts.

A MIP can take the inputs for the driver assignment and output the driver assignment.

FIG. 4B is a flowchart for a method for providing optimal supply planning (e.g., via a rideshare management server 150 over a network 140, as described above in FIG. 1) for a rideshare management system having a fleet of ridesharing vehicles (e.g., users in fleet 130D, 130E, and 130F, as described above in FIG. 1), according to some embodiments of the invention.

The method can involve receiving (e.g., via a rideshare management server 150 over a network 140, as described above in FIG. 1) a desired budget (e.g., main objective) for the optimized supply planning over a future period of time (Step 415).

The budget can be total cost for operation over the future period of time, number of hours for vehicles over the future period of time, or any combination thereof. For example, a total cost can be assigned and depending on the cost per vehicle or varying cost per vehicle, the cost budget can be met. For example, the cost for a first vehicle can differ depending on the time of day. The cost for two different vehicles can differ depending on the experience level of the driver, or the area that the vehicle drives within. In some embodiments, the number of vehicle hours on the road is the budget. The number of vehicle hours on the road can be achieved by any number of vehicles and/or achieved within further constraints (e.g., labor rules, driver preferences, user input preferences or any combination thereof).

The method can involve receiving one or more sets of predetermined shifts for the optimal supply planning, one or more supply plan objectives, one or more shift constraints, or any combination thereof (Step 425). The one or more sets of predetermined shifts can be received from a user. For example, the one or more set of shifts can be for example, shift 1: 8 am-4 pm, break at 11:30-12, start and end at “north zone lot”. The one or more supply plan objectives can be met demand, OTP, ETA, shifts being the same size, shift lengths distributed in a user defined configuration, or any combination thereof.

The method can involve determining expected demand for a future period of time based on historical demand data (Step 435).

In some embodiments, time series models are used to determine expected demand for a planning period (e.g., a future period, for example, one day, multiple days, a week, or any duration period) based on historical data. In some embodiments, the desired rate of met demand can be determined by using a weighting running average of historical demand data. In some embodiments, seasonality and trend can be accounted for in the desired rate of met demand.

The method can involve determining quality of service (“QoS”) as a function of a number of vehicles for each of a plurality of time bins based on the expected demand (Step 445).

A plurality of time bins can be determined for a time period. The plurality of time bins can be a set of time for the planning period. The time bins can be a ½ hour, 15 minutes or any duration as input by a user.

For each time bin, a demand level can be determined. The demand level can be based on historical demand. The historical demand can be used to train machine learning algorithms such that the machine learning algorithms can learn an expected demand based on the historical demand.

The historical demand used can be any desired historical demand. For example, the historical demand can be the historical demand for the same geographical region the required supply for the future period is to be determined for. The historical demand can be historical demand for urban environments, rural environments, service zones, time of day, day of week, weather, for a particular country having for example, the same rules. Each grouping of historical demand can train a different machine learning algorithm. The machine learning algorithms can be deep learning neural networks (e.g., CNN or time series methods such as ARIMA]

For each time bin, for the predicted demand at that time bin, all (or substantially all of) the historical result samples with a similar demand can be determined. The historical result samples can include the historical level of supply at the time of the time bin and the obtained level of QoS.

A percentage of met demand and/or levels of other QoS measurements can be determined as a function of vehicle supply for each time bin based on the historical demand. The percentage of met demand can be determined using isotonic regression (e.g., regression which can allow for piecewise-linear functions and that is monotonically increasing), between the level of supply available at each sample and the QoS level achieved. The percentage of met demand can be based on a similarity between the historical demand and the expected demand.

In some embodiments, before determining demand level, the historical demand data can be filtered. For example, the historical demand data can be filtered based on expected weather, time of day, or any combination thereof.

The method can involve determine optimized shifts for the rideshare management system that maximizes the quality of services based on the function in each of the plurality of time bins, the one or more shift constraints, the desired budget, or any combination thereof (Step 450). The optimized shifts can be determined to ensure that the one or more shift constraints are met, and/or the shifts are within or under the desired budget.

Determining optimized shifts can involve generating all (or substantially all) possible shift structures (e.g., lengths, breaks time, breaks lengths) according to labor rules. In some embodiments, the labor rules are input by a user, or retrieved directly from the internet.

A ramp model from a plurality of ramp models can be selected (e.g., loaded from memory), as described above with respect to FIG. 4A.

Determining optimized shifts can also involve creating a linear discrete optimization program (e.g., Mixed Integer Program (“MIP”)). The MIP can be a representation of variables, objectives, and/or constraints.

Constraints can include shift constraints, labor rules, breakdown to service zones, vehicle types, available vehicles, vehicle availability schedule, number of riders per vehicle, minimum supply at particular time bins, and the time required for a vehicle to be handed over from the end of one shift to the start of the next shift, existing shifts that must be kept as is or with small allowed changes, or any combination thereof.

The variables can represent a number of shifts of each shift structure which can start at each given time bin. For example, how many shifts of a first structure type starts at time bin 1, how many shifts of a second structure type starts at time bin 1, how many shifts of the first structure type starts at time bin 2. A shift structure can be: Drive 2 hours, break 45 minutes, drive 3.5 hours.

Additional variables and/or constraints can model a connection between the number of shifts which are active at each time bin and the predicted met demand (e.g., and/or level of other QoS measurements) based on the functions as determined above. Objectives can include the optimization of QoS measurements and/or minimizing the cost (e.g., in the scenario where the QoS objectives can be obtained within the budget).

The MIP can find the optimal value given the variables and constraints. The MIP can take as input the functions as from the time bins. The MIP can obtain a solution, convert the solution to an optimized shift plan with a valid vehicle assignment to each shift. Converting the solution to an optimized shift plan can involve converting to a shift plan by creating shifts according to the variable values selected by (e.g., output by or determined by) the MIP.

The method can involve assigning drivers to each of the optimized shifts based on the determined optimized shifts (Step 460).

The driver assignment can be performed as described above with respect to FIG. 4A.

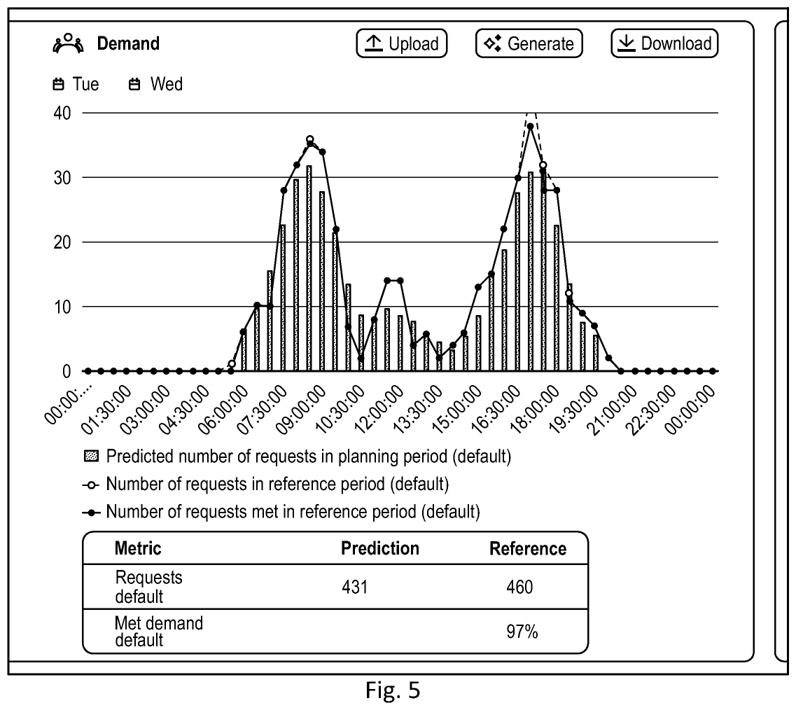

Turning to FIG. 5, FIG. 5 shows an example of demand level (e.g., predicted demand) versus demand at the future time period (e.g., a reference period), according to some embodiments of the invention. As shown in FIG. 5, the number of requests predicted is 431, and the actual demand, the actual number of requests is 460, thus, the met demand is 97%.

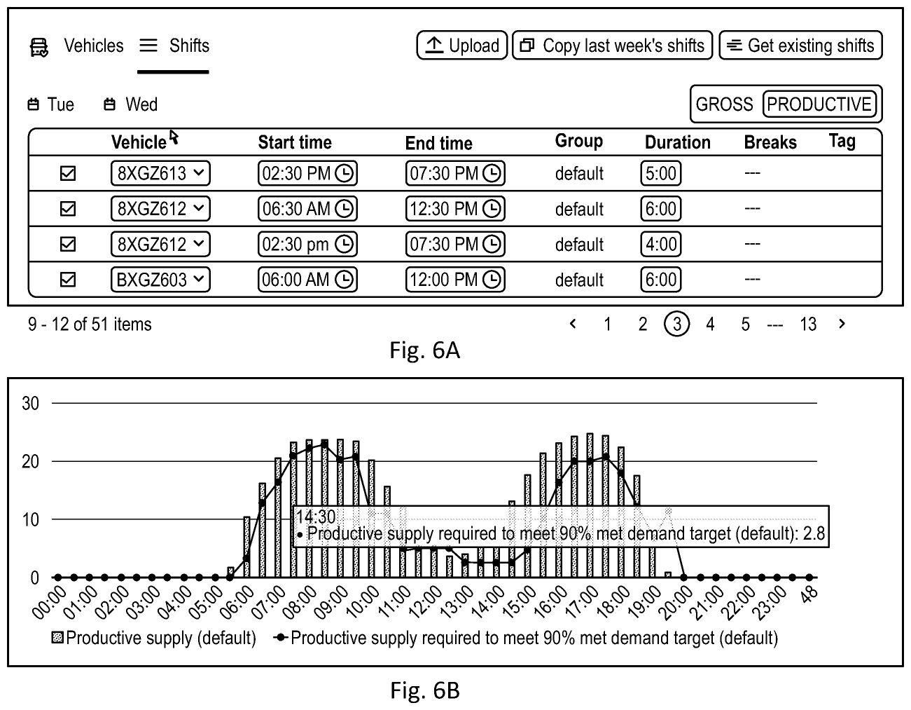

FIG. 6A shows example of planned shifts at the future time period as pulled from a database (e.g., the reference period) and a list of available vehicles, according to some embodiments of the invention. A user can modify the example planned shifts to create, for example, the set of predetermined shifts. FIG. 6B shows an example of determined supply versus actual supply at the future time period (e.g., the reference period), according to some embodiments of the invention.

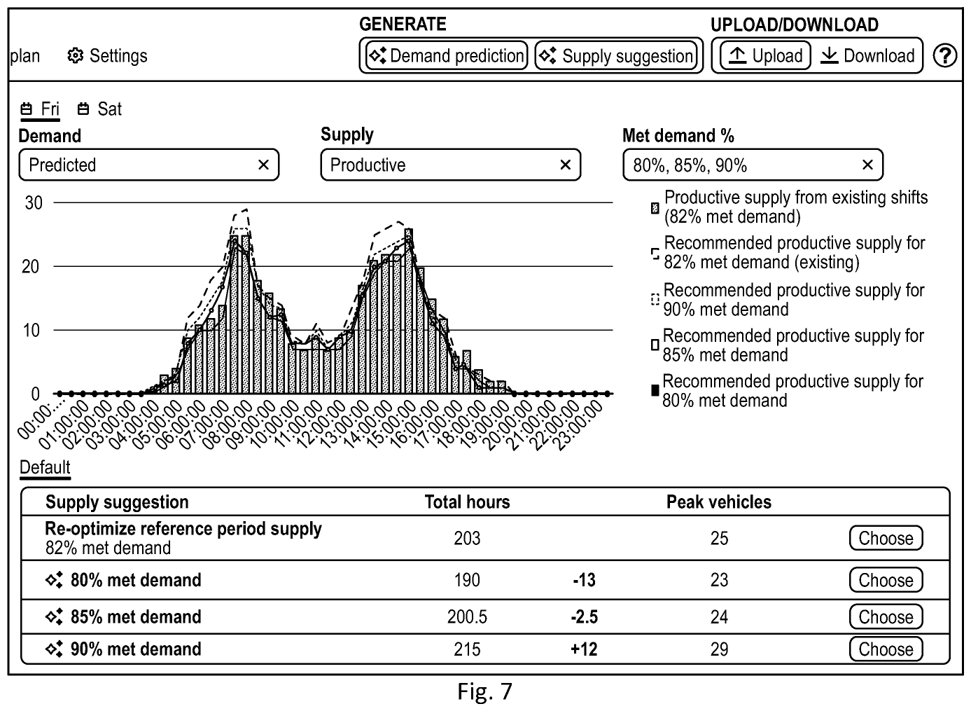

FIG. 7 shows multiple supply options for various met demand levels according to some embodiments of the invention. As shown in this example of FIG. 7, each met demand level can require a different vehicle hours budget. As is apparent to one of ordinary skill, in some embodiments, the multiple met demand levels have the same vehicle hours budget and other met demand levels have different vehicle hours budget.

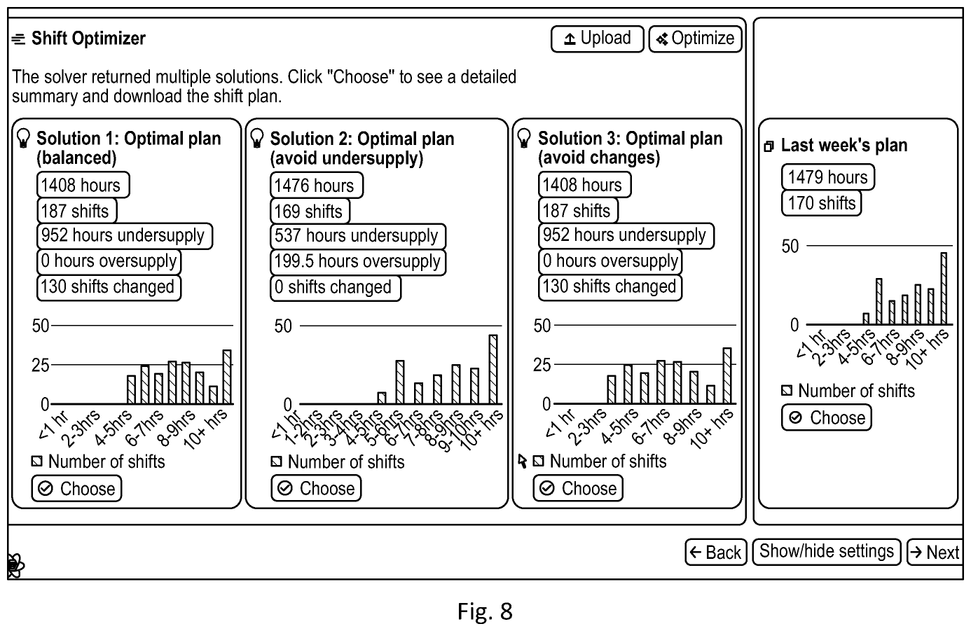

FIG. 8 shows an example of providing multiple shift plan options to a user, according to some embodiments of the invention. In this manner, a user can compare different solutions that arise from prioritizing different objectives and choose which option meets their needs the best.

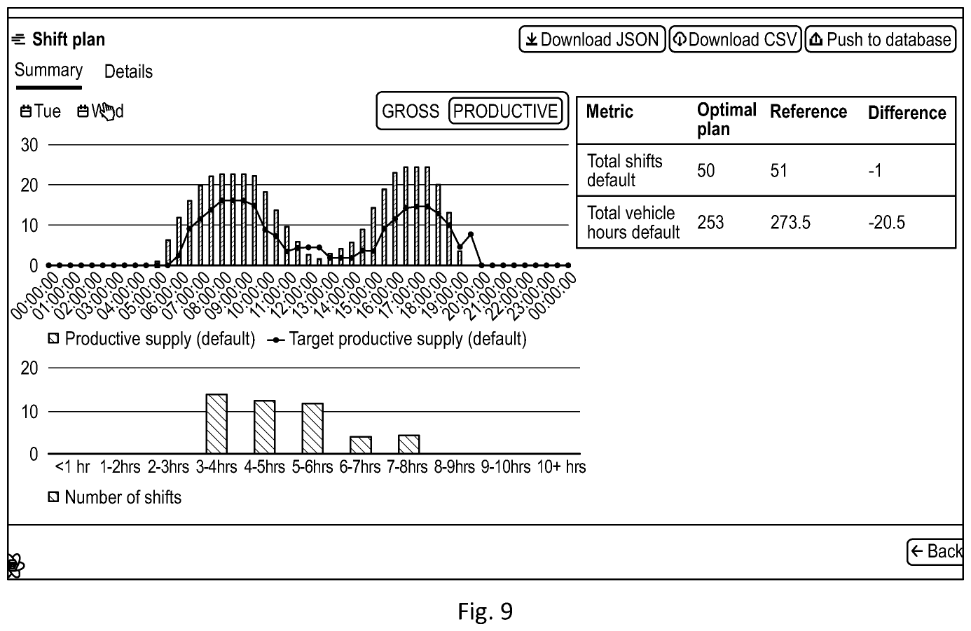

FIG. 9 shows an expanded information view of a selection option of FIG. 8 according to some embodiments of the invention.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A system for providing optimized supply planning for a rideshare management system, the system comprising:
a communications interface configured to:
receive a desired budget for the optimized supply planning over a future period of time;
receive one or more shift constraints for the optimized supply planning;
at least one processor configured to:
determine expected demand for the future period of time based on historical demand data;
determine quality of service as a function of a number of vehicles for each of a plurality of time bins based on the expected demand; and
determine optimized shifts for the rideshare management system that maximizes the quality of service based on the function in each of the plurality of time bins, the one or more shift constraints, the desired budget or any combination thereof.

2. The system of claim 1 wherein the processor is further configured to:
assign drivers to each of the optimized shifts based on driver availability, driver preferences, labor rules, salaries, or any combination thereof.

3. The system of claim 1 wherein the budget is total cost for operation over the future period of time, number of hours for vehicles over the future period of time, or any combination thereof.

4. The system of claim 1 wherein determining optimized shifts is further based one or more set of predetermined shifts for the optimal supply planning, one or more supply plan objectives or any combination thereof.

5. The system of claim 1 wherein determining the quality of service is further based on machine learning.

6. The system of claim 1 wherein determining the quality of service is further based on expected weather, expected time of day, or any combination thereof.

7. The system of claim 1 wherein determining the quality of service is further based on met demand, on-time performance, time it takes to serve an on-demand ride, or any combination thereof.

8. The system of claim 1 determining the optimized shifts further comprises:
determining contribution that a shift at a start of the shift, end of a shift or around a break time during the shift or any combination thereof has on the number of available vehicles.

9. The system of claim 8 wherein the contribution is a fractional contribution to the number of available vehicles.

10. A system for providing optimized supply planning for a rideshare management system, the system comprising:
a communications interface configured to:
receive a desired rate of met demand;
receive one or more shift constraints, or any combination thereof;
at least one processor configured to:
determine expected demand for a future period of time based on historical demand data;
determine required supply for the future period of time based on the expected demand and the desired rate of met demand;
determine optimized shifts for a plurality of vehicles in the rideshare management systems based on the determined required supply, one or more supply plan objectives, one or more shift constraints, or any combination thereof.

11. The system of claim 1 wherein determining optimized shifts is further based one or more set of predetermined shifts for the optimal supply planning, one or more supply plan objectives.

12. The system of claim 1 wherein the processor is further configured to:
assign drivers to each of the optimized shifts based on the determined optimized shifts.

13. The system of claim 1 wherein determining required supply for the future period of time comprises:
determine demand level for each of a plurality of time bins to create an expected demand for each time bin based on historical met demand;
determine a percentage of demand met as a function of vehicle supply for each of the plurality of time bins based on the historical met demand; and
create a target supply vector based on the function.

14. The system of claim 13 wherein determining the demand level is based on machine learning.

15. The system of claim 13 wherein the demand level for each of the plurality of time bins is further based on expected weather.

16. The system of claim 1 wherein determining required supply for the future period of time is further based on number of bookings for a future period, expected number of passengers vs. expected number of bookings, weather prediction, or any combination thereof.

17. The system of claim 13 wherein determining optimized shifts is further based on the target supply vector.

18. The system of claim 1 determining the optimized shifts further comprises:
determining contribution that a shift at a start of the shift, end of a shift or around a break time during the shift or any combination thereof has on a number of available vehicles.

19. The system of claim 18 wherein the contribution is a fractional contribution to the number of available vehicles.
